(19) United States
(12) Patent Application Publication
(10) Pub. No.: US 2005/0129961 A1
(43) Pub. Date: Jun. 16, 2005

(54) Method for separating ashes in combustion installations

(75) Inventor: Klaus Deller, Hainburg (DE)

Correspondence Address: VENABLE, BAETJER, HOWARD AND CIVILETTI, LLP, P.O. BOX 34385, WASHINGTON, DC, 20043-9998, US

(73) Assignee: Degussa AG, Hanau-Wolfgang (DE)

(21) Appl. No.: 10/498,554

(22) PCT Filed: Nov. 28, 2002
(86) PCT No.: PCT/EP02/13413

(30) Foreign Application Priority Data
Dec. 13, 2001 (DE) 101 61 260.5
Aug. 1, 2002 (DE) 102 35 170.8

(51) Int. Cl. B32B 9/04

(52) U.S. Cl. 428/446

(57) ABSTRACT

The invention relates to a method for separating ashes from the exhaust gases of combustion installations by means of separating devices. According to the invention, a hydrophobic, pyrogenically produced silicic acid is introduced into the flow of exhaust gas.

The invention relates to a process for separating ashes in combustion installations.

Combustion installations such as coal-fired power stations and in particular waste incinerators are required to separate the ashes arising on combustion from the waste gases and to dispose of them in a hazardous waste landfill site or put them to another approved use.

It is known to separate the ashes from waste gases by using filters or filter systems which are connected in series. One filter system used to separate ultra-fine ashes is an electrostatic dust filter.

In the electrostatic dust filter, the ultra-fine ash, which cannot be separated on the upstream surfaces, is ionised with high voltages. The charged particles then migrate to the oppositely charged separator plate, from where they are pushed into a hopper by a scraper.

Under this hopper are located conveying means to a bunker, from which the residues are transported onwards to a landfill site, for example by truck.

The known process has the disadvantage that the very finely divided dust builds up in the filter and clogs the hopper, preventing the dust from trickling down onto the conveying means.

The object of the invention was accordingly to provide a process for separating ashes in combustion installations which does not exhibit said disadvantage.

The invention provides a process for purifying waste gases from combustion installations by means of separation apparatuses, which process is characterised in that a hydrophobised, pyrogenically produced silica is introduced into the waste gas stream, said silica being vortexed with the ash particles.

In a preferred embodiment of the invention, the hydrophobic, pyrogenically produced silica may be added upstream from the separation apparatus, such as for example the electrostatic dust filter.

The hydrophobised, pyrogenically produced silica used may comprise silicas which have been surface-modified or hydrophobised with the following substances: dimethyldichlorosilane.

The hydrophobic, pyrogenically produced silica may be introduced, for example, by means of blowing.

The hydrophobic, pyrogenically produced silica is known from Ullmann's Enzyklopadie der technischen Chemie, 4th edition, volume 21, pages 466 to 467.

The hydrophobic, pyrogenically produced silica may be added in a quantity of 0.1 to 0.2 kg per tonne of incinerated domestic waste.

The commercially available grades of silica (hydrophobic Aerosil®) listed in Table 1 may be used as the hydrophobic, pyrogenically produced silica.

TABLE 1
Hydrophobic AEROSIL ®

| | AEROSIL | AEROSIL | AEROSIL | AEROSIL | AEROSIL | AEROSIL | AEROSIL | AEROSIL | AEROSIL | AEROSIL |
|---|---|---|---|---|---|---|---|---|---|---|
| Test method | R972 | R974 | R202 | R805 | R812 | R812S | R104 | R106 | R8200 | R816 |
| Behaviour | hydrophobic | | | | | | | | | |
| towards water | | | | | | | | | | |
| Appearance | loose white powder | | | | | | | | | |
| BET surface | 110 ± 20 | 170 ± 20 | 100 ± 20 | 150 ± 25 | 260 ± 30 | 220 ± 25 | 150 ± 25 | 150 ± 30 | 160 ± 25 | 170 ± 25 |
| area¹⁾ m²/g | | | | | | | | | | |
| Average primary | 16 | 12 | 14 | 12 | 7 | 7 | 12 | 7 | 12 | 12 |
| particle size nm | | | | | | | | | | |
| Tamped density, | 50 | 50 | 50 | 50 | 50 | 50 | 50 | 50 | 140 | 40 |
| approx. value²⁾ | | | | | | | | | | |
| standard product | | | | | | | | | | |
| g/l | | | | | | | | | | |
| compacted | 90 | 90 | | | | | 90 | | | |
| product | | | | | | | | | | |
| (suffix “V”) g/l | | | | | | | | | | |
| Drying loss³⁾ | <0.5 | <0.5 | <0.5 | <0.5 | <0.5 | <0.5 | <0.5 | <0.5 | <0.5 | <1.0 |
| (2 h at 105° C.) | | | | | | | | | | |
| on departure from | | | | | | | | | | |
| the supplier's | | | | | | | | | | |
| works % | | | | | | | | | | |
| Ignition loss⁴⁾⁷⁾ | <2 | <2 | 4-6 | 5-7 | 1.0-2.5 | 1.3-3.0 | 1.0-2.5 | 1.0-2.5 | 2.5-3.5 | 2.4-4.0 |
| (2 h at | | | | | | | | | | |
| 1000° C.) % | | | | | | | | | | |
| C content % | 0.6-1.2 | 0.7-1.3 | 3.5-5.0 | 4.5-6.5 | 2.0-3.0 | 3.0-4.0 | 1-2 | 1.5-3.0 | 2.0-4.0 | 1.2-2.2 |
| pH value⁵⁾¹⁰⁾ % | 3.6-4.4 | 3.7-4.7 | 4-6 | 3.5-5.5 | 5.5-7.5 | 5.5-7.5 | >4.0 | >3.7 | >5.0 | 4.4-5.5 |
| SiO₂⁸⁾ % | >99.8 | >99.8 | >99.8 | >99.8 | >99.8 | >99.8 | >99.8 | >99.8 | >99.8 | >99.8 |
| Al₂O₃⁸⁾ % | <0.05 | <0.05 | <0.05 | <0.05 | <0.05 | <0.05 | <0.05 | <0.05 | | <0.05 |
| Fe₂O₃⁸⁾ % | <0.01 | <0.01 | <0.01 | <0.01 | <0.01 | <0.01 | <0.01 | <0.01 | <0.01 | <0.01 |
| TiO₂⁸⁾ % | 0.03 | 0.03 | 0.03 | 0.03 | 0.03 | 0.03 | 0.03 | 0.03 | 0.03 | 0.03 |
| HCl¹¹⁾ % | <0.05 | <0.1 | <0.025 | <0.025 | <0.025 | <0.025 | <0.02 | <0.025 | <0.025 | <0.025 |

¹⁾on the basis of DIN 66131
²⁾on the basis of DIN ISO 4787/XI, JIS K 51018/18 (unscreened)
³⁾on the basis of DIN ISO 787/II ASTM D 280, JIS K 5101/21
⁴⁾on the basis of DIN 55921, ASTM D 1208, JIS K 5101/23
⁵⁾on the basis of DIN ISO 787/IX, ASTM D 1208, JIS K 5101/24
⁷⁾relative to material dried for 2 hours at 105° C.
⁸⁾relative to material calcined for 2 hours at 1000° C.
¹⁰⁾in water:methanol = 1:1
¹¹⁾HCl content is part of ignition loss

In a preferred embodiment of the invention, the hydrophobic, pyrogenically produced silica Aerosil 972 may be used.

Silica Aerosil R 972 exhibits the following physicochemical parameters:

| | |
|---|---|
| Test method | Aerosil R 972 |

| | |
|---|---|
| Behaviour towards water | hydrophobic |
| Appearance | loose white powder |

| | | |
|---|---|---|
| BET surface area¹⁾ | m²/g | 110 ± 20 |
| Average primary particle size | nm | 16 |
| Tamped density/approx. value²⁾ | | |
| standard product | g/l | 50 |
| compacted product (suffix “V”) | g/l | 90 |
| Drying loss³⁾ | % | <0.5 |
| (2 hours at 105° C.) on departure | | |
| from the supplier's works | | |
| Ignition loss⁴⁾⁷⁾ | % | <2 |
| (2 hours 1000° C.) | | |
| C content | % | 0.6-1.2 |
| pH value⁵⁾¹⁰⁾ | | 3.6-4.4 |
| SiO₂⁸⁾ | % | >99.8 |
| Al₂O₃⁸⁾ | % | >0.05 |
| Fe₂O₃⁸⁾ | % | >0.01 |
| TiO₂⁸⁾ | % | >0.03 |
| HCl⁸⁾¹¹⁾ | % | >0.05 |
| Drum size (net) | kg | 10 |

¹⁾on the basis of DIN 66131
²⁾on the basis of DIN ISO 787/XI, JIS K 5101/18 (unscreened)
³⁾on the basis of DIN ISO 787/II, ASTM D 280, JIS K 5101/21
⁴⁾on the basis of DIN 55921, ASTM D 1208, JIS K 5101/23
⁵⁾on the basis of DIN ISO 787/IX, ASTM D 1208, JIS K 5101/23
⁷⁾relative to material dried for 2 hours at 105° C.
⁸⁾relative to material calcined for 2 hours at 1000° C.
¹⁰⁾in water:methanol = 1:1
¹¹⁾HCl content is part of ignition loss

The process according to the invention has the advantage that the ultra-fine ash no longer builds up in the hopper and, as a consequence, the hopper also no longer becomes clogged.

The process according to the invention has been successfully trialled under practical conditions in collaboration with Mr. Wolfgang Zieger and Mr. Franz W. Albert at the Mannheim combined heat and power station/refuse incinerator.

The process according to the invention is illustrated and described in greater detail with reference the drawings, which relate to the schematic diagram of the Mannheim refuse incinerator:

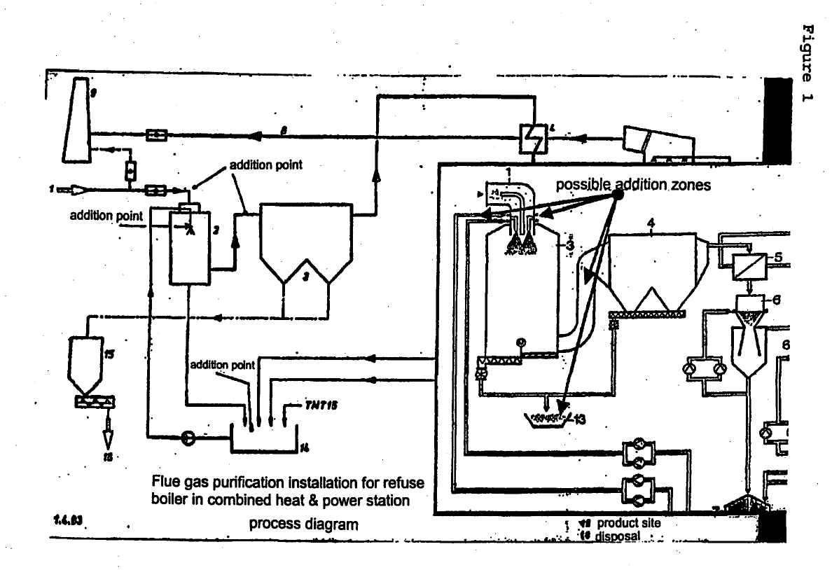

FIG. 1: possible addition points for adding Aerosil R 972 in the vicinity of the spray dryer 2(3) and the electrostatic dust filter 3(4)

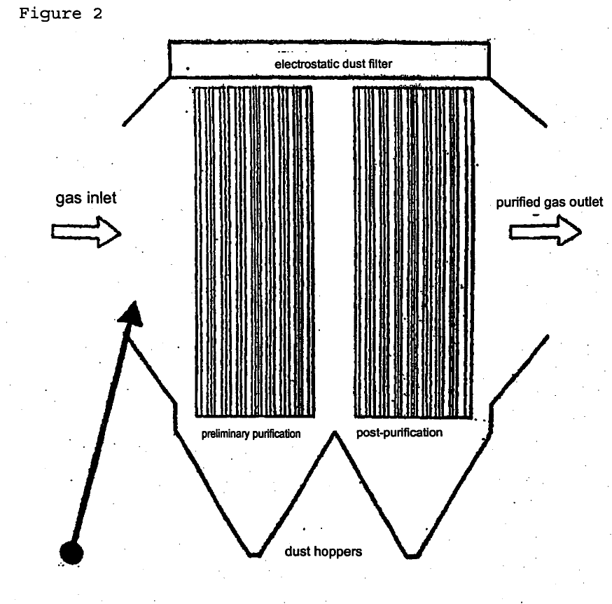

FIG. 2: a possible addition point for adding Aerosil R972 in the vicinity of the gas inlet of the electrostatic dust filter downstream from the end of the boiler and upstream from the electrostatic dust filter

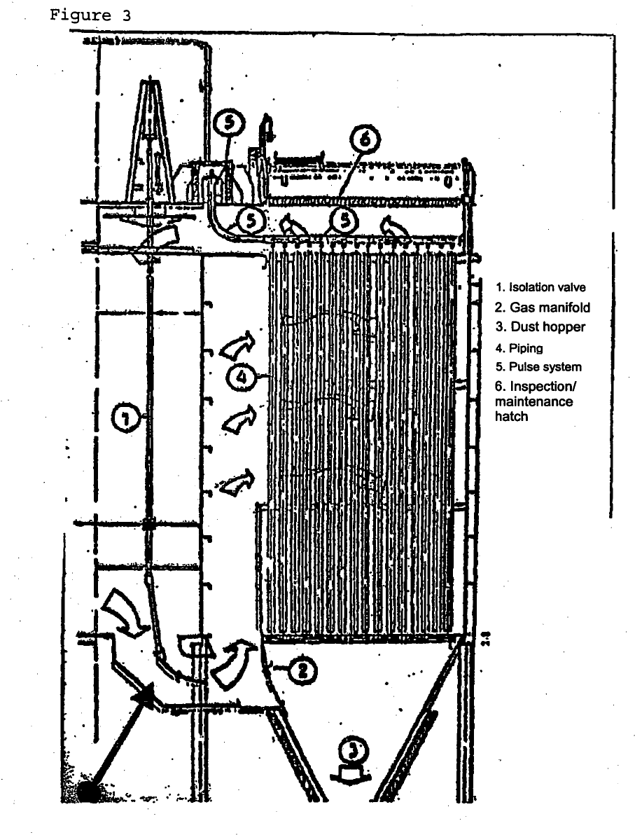

FIG. 3: a possible addition point for adding Aerosil R972 downstream from the end of the boiler and upstream from the woven fabric filter

According to FIG. 1, Aerosil R 972 is added at various points in the flue gas removal zone. The Aerosil R 972 may be added to the product suspension in the mixing apparatus 14. It may be introduced via the compressed air for the spray dryer.

It may be introduced at the outlet from the spray dryer. According to FIG. 2 and FIG. 3, addition is made in the boiler zone at the gas inlet upstream from the electrostatic dust filter or the woven fabric filter respectively.

1. A process for purifying waste gases from combustion installations by means of separation apparatuses comprising introducing a hydrophobic, pyrogenically produced silica into the waste gas stream so that the silica mixes with the ash particles contained in the waste gas stream associated with the separation apparatus.

2. A process according to claim 1, further comprising introducing hydrophobic, pyrogenically produced silica upstream from the separation apparatus.
